(19) United States
(12) Patent Application Publication
(10) Pub. No.: US 2022/0079318 A1
(43) Pub. Date: Mar. 17, 2022

(54) HAIR DRYER

(71) Applicant: Tuanfang LIU, Shenzhen (CN)

(72) Inventor: Tuanfang LIU, Shenzhen (CN)

(21) Appl. No.: 17/133,569

(22) Filed: Dec. 23, 2020

(30) Foreign Application Priority Data
Sep. 17, 2020 (CN) 202010981594.4
Sep. 17, 2020 (CN) 202022048710.5

(51) Int. Cl. A45D 20/12

(52) U.S. Cl. CPC A45D 20/12

(57) ABSTRACT

A hair dryer includes a magnetic induction heating module and a blowing device. The magnetic induction heating module includes a heating element and a magnetic induction coil. The heating element is disposed in the magnetic induction coil and produces heat in a power-on state. The magnetic induction heating module is disposed in the blowing device.

### CROSS-REFERENCE TO RELATED APPLICATIONS

Pursuant to 35 U.S.C. § 119 and the Paris Convention Treaty, this application claims foreign priority to Chinese Patent Application No. 202010981594.4 filed on Sep. 17, 2020, and to Chinese Patent Application No. 202022048710.5 filed on Sep. 17, 2020. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND

The disclosure relates to a hair dryer.

Conventionally, a hair dryer is driven by a 220 V household power supply and the process is energy-consuming.

### SUMMARY

The disclosure provides a hair dryer, comprising a magnetic induction heating module and a blowing device; the magnetic induction heating module comprises a heating element and a magnetic induction coil; the heating element is disposed in the magnetic induction coil and produces heat in a power-on state; and the magnetic induction heating module is disposed in the blowing device.

In a class of this embodiment, the heating element comprises a first cylinder and a second cylinder; the first cylinder comprises an inner surface comprising a plurality of circumferentially disposed convex teeth; the second cylinder comprises an outer surface comprising a plurality of circumferentially disposed convex teeth; the first cylinder is disposed in the second cylinder.

In a class of this embodiment, the heating element comprises aluminum and an electrically conductive metal.

In a class of this embodiment, the magnetic induction heating module further comprises a variable-frequency power source and a battery; an output end of the variable-frequency power source is soldered on an input end of the magnetic induction coil to supply alternating current for the magnetic induction coil whereby an alternating magnetic field is produced by the magnetic induction coil; positive and negative terminals of the battery are connected to an input end of the variable-frequency power source.

In a class of this embodiment, the blowing device comprises a housing, and the magnetic induction heating module is disposed in the housing.

In a class of this embodiment, the blowing device further comprises a fan disposed in the housing, fixed on the variable-frequency power source, and next to the heating element; the heated air produced by the heating element is blown out of the housing via the fan.

In a class of this embodiment, the blowing device further comprises a power button and a button cover; the power button is soldered on the variable-frequency power source; the button cover is disposed on the power button and is exposed out of the housing; the button cover is configured to switch on/off the battery and to regulate a heating power of the magnetic induction heating module and a rotation speed of the fan.

In a class of this embodiment, the blowing device further comprises a rear cover disposed on the housing; when in use, air is sucked into the heating element via the rear cover and drives the heated air produced by the heating element out of an air outlet of the housing.

### BRIEF DESCRIPTION OF THE DRAWINGS

FIG. 1 is an exploded view of a hair dryer in accordance with one embodiment of the disclosure;

FIG. 2 is a schematic diagram of a hair dryer in accordance with one embodiment of the disclosure;

FIG. 3 is a schematic diagram of a heating element of a hair dryer in accordance with one embodiment of the disclosure;

FIG. 4 is an exploded view of a blowing device of a hair dryer in accordance with one embodiment of the disclosure;

FIG. 5 is a schematic diagram of a blowing device of a hair dryer in accordance with one embodiment of the disclosure;

FIG. 6 is a sectional view of a blowing device of a hair dryer in accordance with one embodiment of the disclosure; and

FIG. 7 shows electronic parameters of a hair dryer in accordance with one embodiment of the disclosure.

### DETAILED DESCRIPTION

To further illustrate, embodiments detailing a hair dryer are described below. It should be noted that the following embodiments are intended to describe and not to limit the disclosure.

Principle of high frequency heating: when an alternating current is introduced to a magnetic induction coil, an alternating magnetic field will be generated. When a metal conductor is placed in the alternating magnetic field, an eddy current is produced. The eddy current makes the metal conductor heated.

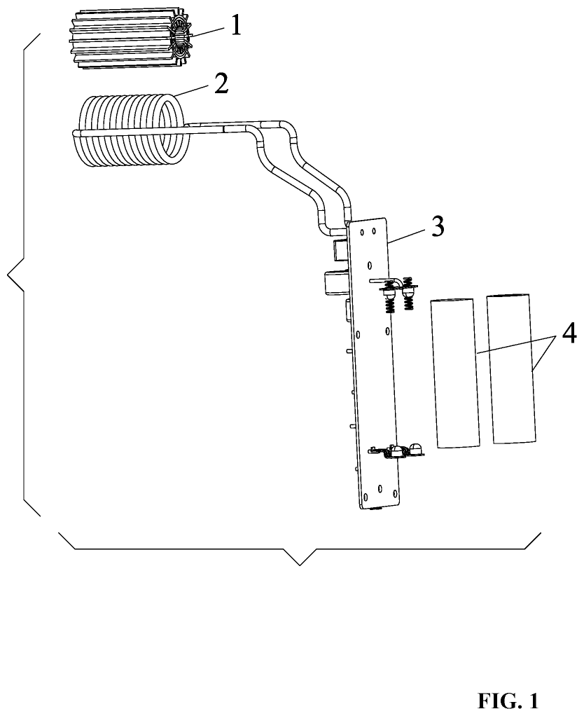

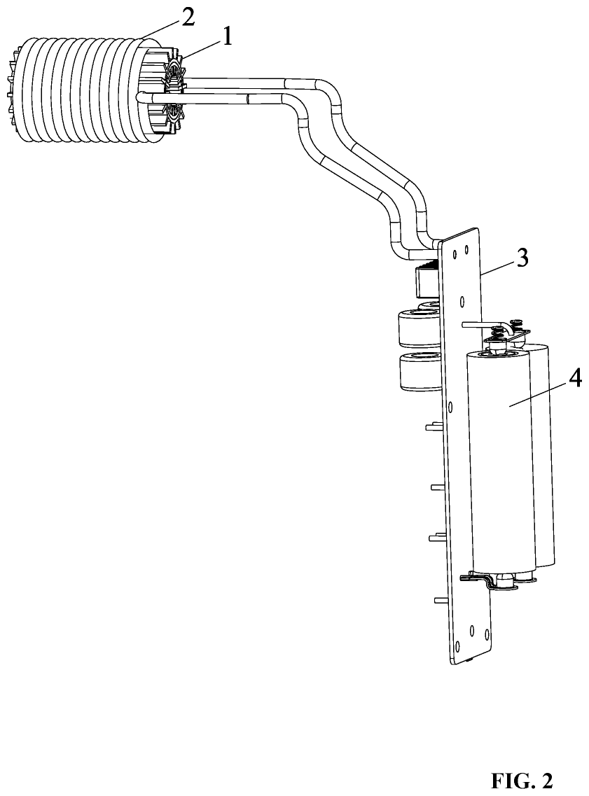

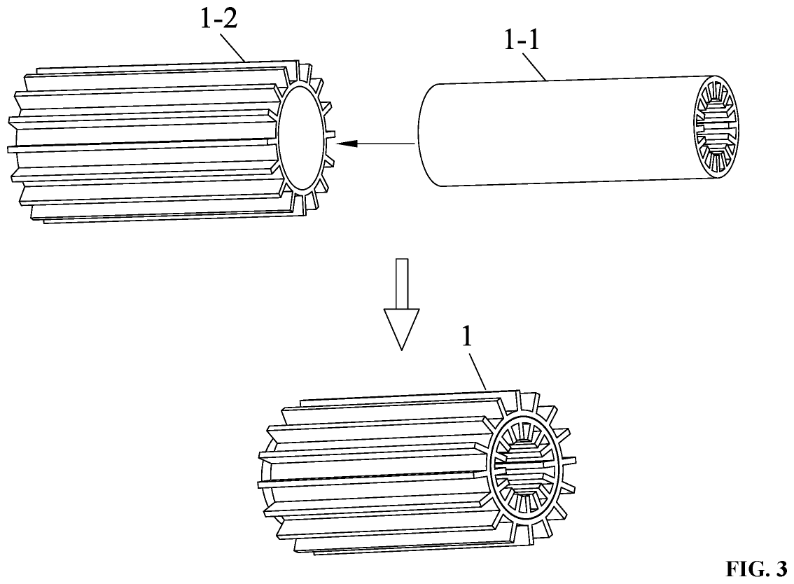

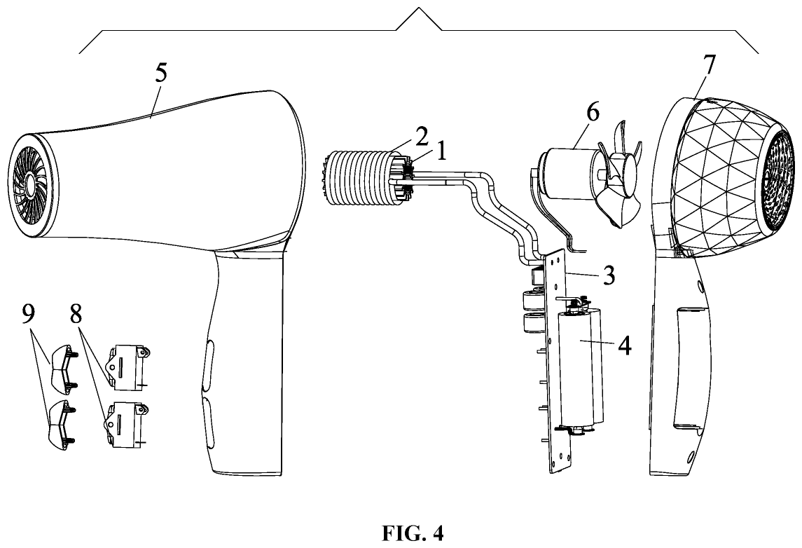

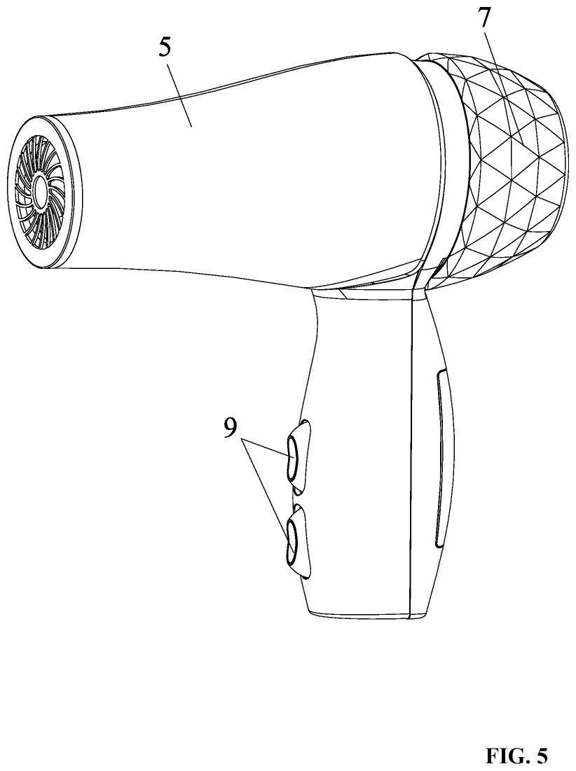

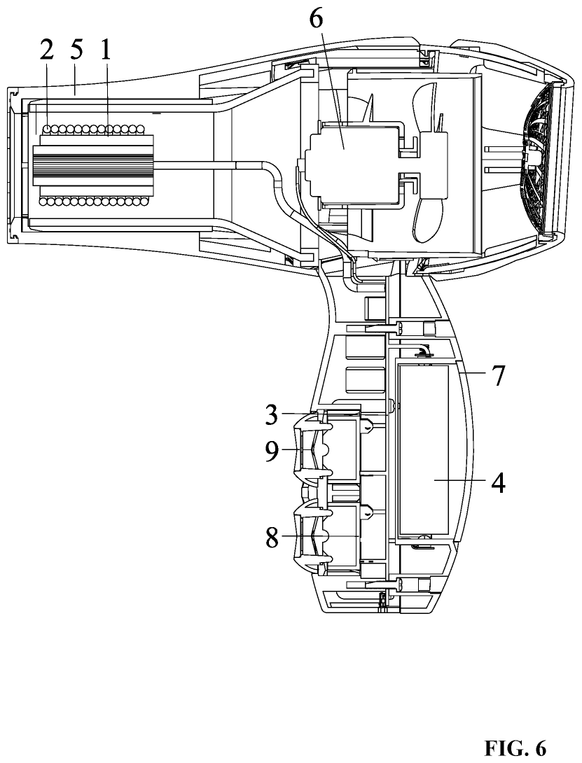

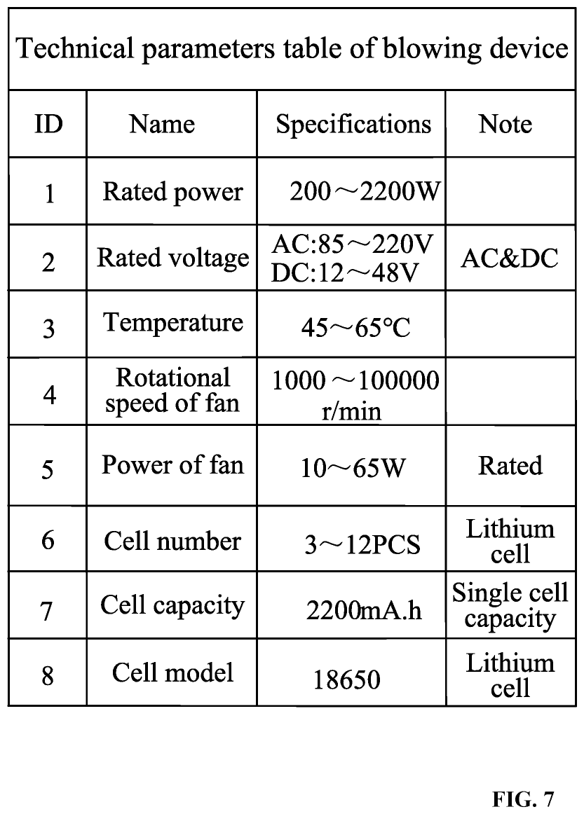

As shown in FIGS. 1-7, the disclosure provides a hair dryer comprising a heating element 1, a magnetic induction coil 2, a variable-frequency power source 3, a battery 4, a housing 5, a fan 6, and a rear cover 7. The heating element 1 comprises a first cylinder 1-1 and a second cylinder 1-2. The first cylinder 1-1 comprises an inner surface comprising a plurality of circumferentially disposed convex teeth. The second cylinder 1-2 comprises an outer surface comprising a plurality of circumferentially disposed convex teeth. The first cylinder 1-1 is disposed in the second cylinder 1-2. The heating element 1 is disposed in the magnetic induction coil 2. The output end of the variable-frequency power source 3 is soldered on the input end of the magnetic induction coil 2 to supply alternating current for the magnetic induction coil 2. In this way, an alternating magnetic field is produced. The positive and negative terminals of the battery 4 are connected to the input end of the variable-frequency power source 3. The heating element 1, the magnetic induction coil 2, the variable-frequency power source 3, and the battery 4 constitute a magnetic induction heating module. The magnetic induction heating module is fixed in the housing 5. A power button 8 is soldered on the variable-frequency power source 3. A button cover 9 is disposed on the power button 8 and is exposed out of the housing 5. The button cover 9 is configured to switch on/off the battery and to regulate the heating power of the magnetic induction heating module and the rotation speed of the fan 6. The fan 6 is disposed in the housing 5, fixed on the variable-frequency power source 3, and next to the heating element 1. The heated air produced by the heating element is blown out of the housing via the fan. The rear cover 7 is disposed on the housing 5.

In certain embodiments, the hair dryer comprises 3-12 18650-type lithium batteries, the capacity of each of which is 2200 mA⋅h. The output power of the hair dryer is 200-2200 W, the voltage is AC: 85-220 V, DC: 12-48 V; the temperature is 45-65° C., the rotation speed of the fan is 1000-100000 rpm, and the power is 10-65 W.

In certain embodiments, the magnetic induction coil 2 is in the shape of a square, circle, triangle, quadrilateral, or polygon comprising a curved surface.

The following advantages are associated with the hair dryer of the disclosure:

1. The hair dryer comprises a magnetic induction heating module and a blowing device, and the magnetic induction heating module is disposed in the blowing device.

2. The hair dryer comprise built-in batteries, no need to use external 220 V household power supply, so the hair dryer is portable.

3. The heating element of the hair dryer comprises a first cylinder and a second cylinder; the first cylinder comprises an inner surface comprising a plurality of circumferentially disposed convex teeth; the second cylinder comprises an outer surface comprising a plurality of circumferentially disposed convex teeth. The design improves the heating power and heating area of the hair dryer.

It will be obvious to those skilled in the art that changes and modifications may be made, and therefore, the aim in the appended claims is to cover all such changes and modifications.

What is claimed is:

1. A hair dryer, comprising a magnetic induction heating module and a blowing device, wherein the magnetic induction heating module comprises a heating element and a magnetic induction coil; the heating element is disposed in the magnetic induction coil and produces heat in a power-on state; and the magnetic induction heating module is disposed in the blowing device.

2. The hair dryer of claim 1, wherein the heating element comprises a first cylinder and a second cylinder; the first cylinder comprises an inner surface comprising a plurality of circumferentially disposed convex teeth; the second cylinder comprises an outer surface comprising a plurality of circumferentially disposed convex teeth; the first cylinder is disposed in the second cylinder.

3. The hair dryer of claim 2, wherein the heating element comprises aluminum and an electrically conductive metal.

4. The hair dryer of claim 3, wherein the magnetic induction heating module further comprises a variable-frequency power source and a battery; an output end of the variable-frequency power source is soldered on an input end of the magnetic induction coil to supply alternating current for the magnetic induction coil whereby an alternating magnetic field is produced by the magnetic induction coil; positive and negative terminals of the battery are connected to an input end of the variable-frequency power source.

5. The hair dryer of claim 4, wherein the blowing device comprises a housing, and the magnetic induction heating module is disposed in the housing.

6. The hair dryer of claim 5, wherein the blowing device further comprises a fan disposed in the housing, fixed on the variable-frequency power source, and next to the heating element; the heated air produced by the heating element is blown out of the housing via the fan. The hair dryer of claim 6, wherein the blowing device further comprises a power button and a button cover; the power button is soldered on the variable-frequency power source; the button cover is disposed on the power button and is exposed out of the housing; the button cover is configured to switch on/off the battery and to regulate a heating power of the magnetic induction heating module and a rotation speed of the fan.

8. The hair dryer of claim 7, wherein the blowing device further comprises a rear cover disposed on the housing; when in use, air is sucked into the heating element via the rear cover and drives the heated air produced by the heating element out of an air outlet of the housing.
